(19) United States
(12) Patent Application Publication
(10) Pub. No.: US 2009/0158999 A1
(43) Pub. Date: Jun. 25, 2009

(54) Manufacturing method for an integrated circuit comprising a multi-layer stack, corresponding integrated circuit and multi-layer mask

(75) Inventor: Mirko Vogt, Dresden (DE)

Correspondence Address: COATS & BENNETT/QIMONDA, 1400 CRESCENT GREEN, SUITE 300, CARY, NC, 27518, US

(73) Assignee: QIMONDA AG, Munchen (DE)

(21) Appl. No.: 11/963,949

(22) Filed: Dec. 24, 2007

(51) Int. Cl. B05C 11/00

(52) U.S. Cl. 118/504

(57) ABSTRACT

The present invention provides a manufacturing method for an integrated circuit comprising a multi-layer stack and a corresponding integrated circuit. In the method a first layer is deposited on a substrate in a plasma deposition process in a plasma chamber using a first reaction gas having at least one first gas component which is introduced at a first flow rate into the chamber. Thereafter a second layer is deposited in situ on the first layer in the plasma deposition process in the plasma chamber using a second reaction gas having at least one second gas component which is introduced at a second flow rate into the chamber. In a switching transition period from the first to the second flow rate a transition layer including a gradual composition transition from the first to the second layer is formed.

### BACKGROUND OF THE INVENTION

1. Field of the Invention

The present invention generally relates to a manufacturing method for an integrated circuit comprising a multi-layer stack, a corresponding integrated circuit and a multi-layer mask.

2. Related Art

For manufacturing integrated circuits using modern lithographic methods, multi-layer stacks are required which are patterned and thereafter used as masks, e.g. in etch processes.

The choice of the individual layers of a multi-layer stack is generally made according to their optic properties, their etching rates, and their etching selectivities. A frequently used material combination is an alternating layer sequence of SiON and amorphous silicon or an alternating layer sequence of SiO and SiN. In principle, all conceivable combinations of Si-containing compounds can be used, in particular all combinations of SiO, SiN, SiON, amorphous Si, SiC, SiCO, . . . .

### DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

In the Figures:

FIG. 1 shows an integrated circuit comprising a multilayer stack;

FIGS. 2a,b show time dependencies of a reaction gas flow rate and reaction gas concentration, respectively, of a plasma deposition process according to a first embodiment of the present invention;

FIGS. 3a,b show time dependencies of a reaction gas flow rate and reaction gas concentration, respectively, of a plasma deposition process according to a second embodiment of the present invention; and

FIG. 4 shows an integrated circuit comprising a multilayer stack manufactured in a plasma deposition process according to the first or second embodiment of the present invention.

In the Figures, identical reference signs denote equivalent or functionally equivalent components.

### DESCRIPTION OF THE PREFERRED EMBODIMENTS

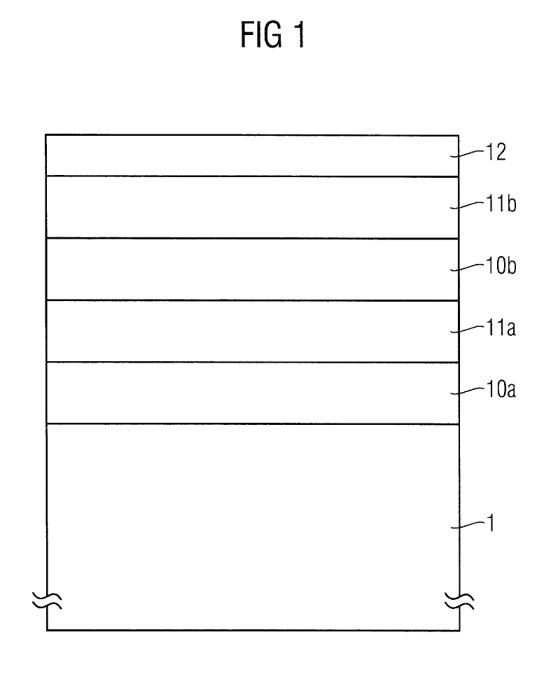

FIG. 1 shows an integrated circuit comprising a multi-layer stack.

In FIG. 1 reference sign 1 denotes a semiconductor substrate, e.g. a silicon substrate, including (not shown) integrated circuits. A multi-layer sequence of five individual layers 10a, 11a, 10b, 11b, 12 is deposited on the upper surface of said substrate 1. Reference sign 10a denotes a first SiON layer, 11a a denotes a first amorphous silicon layer, 10b a second SiON layer, 11b a second amorphous silicon layer, and 12 a SiO layer. The layer sequence 10a, 11a, 10b, 11b, 12 is patterned using standard lithography techniques and may be particularly used as a mask in techniques like pitch fragmentation and double-patterning.

One possible method of producing the multi-layer stack 10a, 11a, 10b, 11b, 12 is by means of high temperature furnace CVD deposition processes (CVD=chemical vapor deposition). In such high temperature furnace processes, both the front and back side of the wafer and the wafer etch are coated in conformal manner which provides an excellent adhesion of the individual layers.

On the other hand, there are also plasma-enhanced PECVD processes wherein the multi-layer stack 10a, 11a, 10b, 11b, 12 is deposited in a plasma reactor using respective reaction gases having one or more gas components which are introduced into the burning plasma.

The plasma is interrupted between the deposition of two consecutive layers. During such a plasma interrupt, the plasma chamber is purged in order to remove remaining gases from the previous plasma reaction and to prepare the plasma chamber for the next plasma process using a different reaction gas having one or more different gas components. After the purge, the reaction gas for the next plasma deposition is introduced, the pressure is stabilized, and the plasma is re-ignited for deposition.

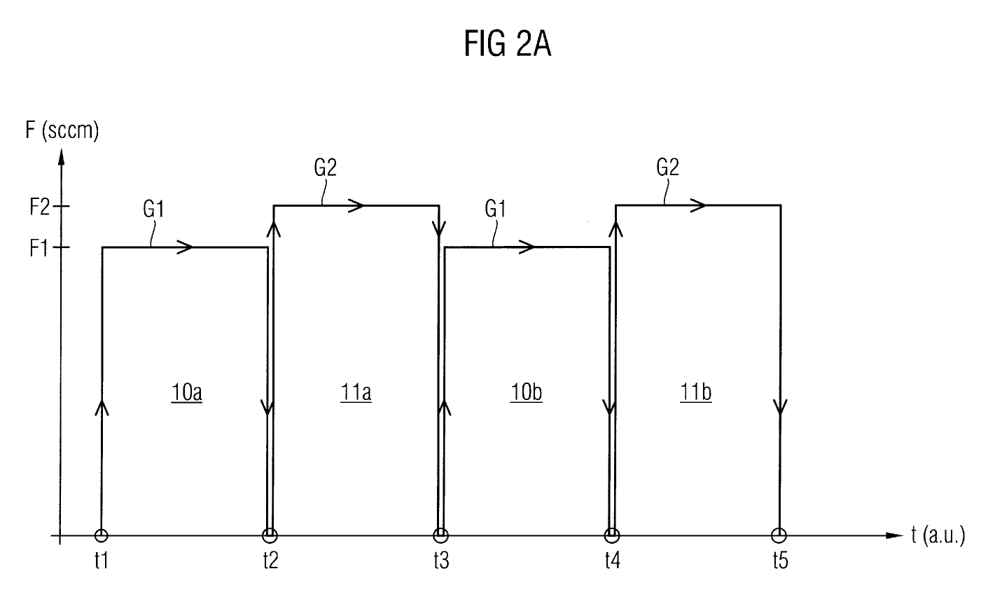

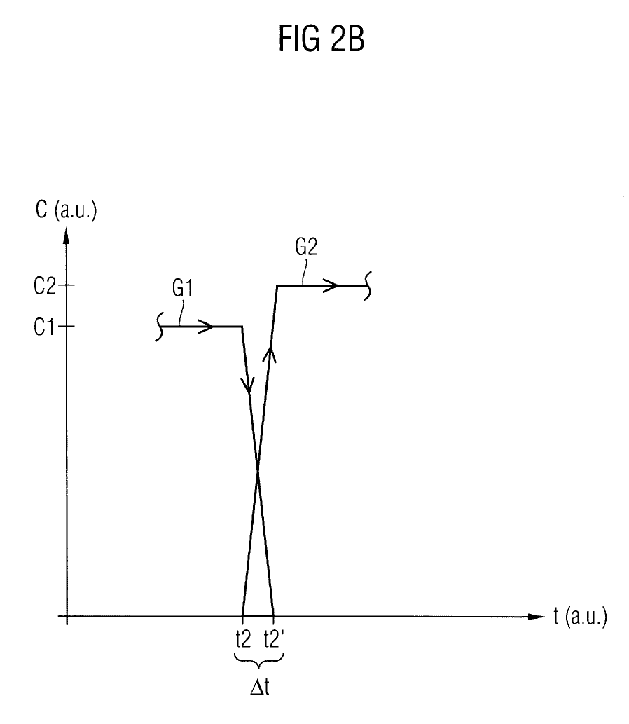

FIGS. 2a,b show time dependencies of a reaction gas flow rate and reaction gas concentration, respectively, of a plasma deposition process according to a first embodiment of the present invention.

In FIG. 2a, the abscissa label t denotes the process time, whereas the ordinate label F (sccm) denotes a set point flow rate of the respective reaction gas G1 and G2, respectively.

In order to sequentially form the first SiON layer 10a, the first amorphous silicon layer 11a, the second SiON layer 10b, and second amorphous silicon layer 11b, the following process sequence is performed.

After the atmosphere in the plasma chamber has been stabilized at time t1, and the flow rate of the first reaction gas having the gas components SiH₄ and N₂O has reached a value of F1 which amounts to approximately 1300 sccm in this example, the plasma is ignited. It should be mentioned that The reaction gas may also include a certain fraction of an inert gas such as He, e.g. 9000 sccm.

The flow rate F1 of the first reaction gas G1 is kept constant between time t1 and time t2. At time t2, the set point flow rate of the first reaction gas is abruptly decreased to zero, e.g. by shutting corresponding valves. At the same time, the flow rate of the second reaction gas G2 which is SiH₄ is increased abruptly to a flow rate F2 of 1500 sccm. The flow rate of an additional inert gas can be kept constant or slightly modified. Between time t2 and time t3 the flow rate of the second reaction gas G2 is kept constant at the value of F2. At time t3, the flow rate of the second reaction gas G2 is abruptly reduced to zero, and the flow rate of the first reaction gas G1 is abruptly increased to the value of F1. At time t4, the flow rate of the first reaction gas G1 is abruptly reduced to zero and the flow rate of the second reaction gas G2 is abruptly increased to the value of F2. At time t5, the deposition of the sequence of the layers 10a, 11a, 10b, 11b has been completed.

In this process sequence the plasma is not interrupted at the times t2, t3, and t4, but kept continuously burning from t1 to t5. This has the consequence that a transition layer including a gradual composition transition from the underlying layer to the overlying layer is formed at times t2, t3, t4, because all plasma parameters are kept constant and only the flow rates are switched by operating corresponding valves.

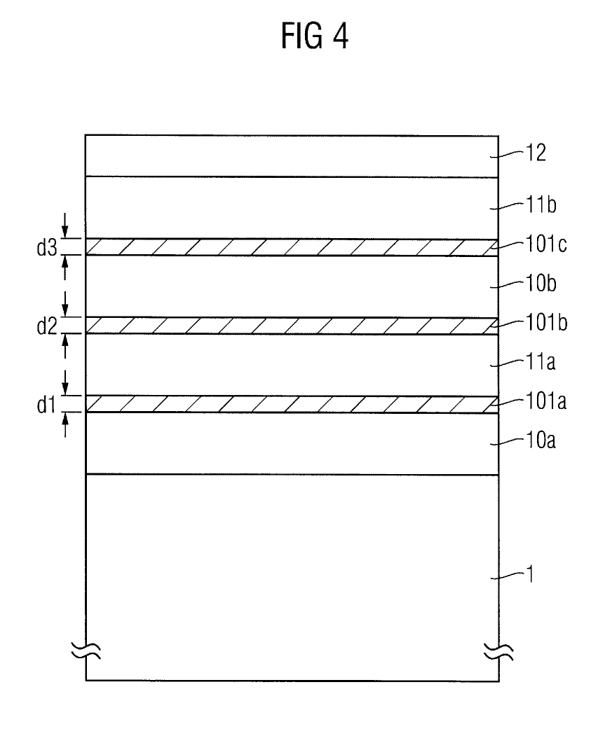

By providing such a gradual transition layer which is labelled 101a, 101b, 101c in FIG. 4 between the layers 10a and 11a, 11a and 10b, 10b and 11b, a good adhesion between the individual layers 10a and 11a, 11a and 10b, 10b and 11b can be achieved, and the PECVD deposition process is efficient because its reduced process time compared to the example where the plasma is extinguished after each layer and a respective purge is performed. Also, defects are mainly created when the plasma is switched off. Thus, a reduction of the plasma turn-off times effects a reduction of the defects.

Although in this example all plasma parameters are kept constant and only the set point flow rates are switched, it should be mentioned that an adaption of certain plasma parameters, such as pressure or power, might be required in order to provide a soft process transition from one layer to the next layer without disturbing pressure or causing plasma instabilities. However, the plasma is kept continuously burning, even if an adaption of such plasma parameters is performed.

The reason for the occurrence of transition layers 101a, 101b, 101c shown in FIG. 4 will be explained with respect to FIG. 2b.

FIG. 2b shows the reaction gas concentration C in the vicinity of the flow set point switching time t2. At t2, the concentration C1 of the first reaction gas G1 is changed from a constant value C1 to zero by abruptly shutting respective valves. However, due to the presence of the reaction gas G1 in the plasma chamber and the limited response time of the system, the concentration of the first reaction gas G1 will not fall abruptly to zero, but it will take until time t2′ until it becomes zero. In other words there will be a relaxation time Δt, where a certain decreasing concentration of the first reaction G1 is still present in the plasma chamber.

Analogously, at time t2, the set point flow rate of the second reaction gas is abruptly increased to F2, however, the concentration of the second reaction gas G2 will also increase to the value C2 with the relaxation time Δt.

Consequently, the value of the relaxation time Δt determines the thickness of the transition layer 101a which starts to be formed at time t2 and which is labeled d1 in FIG. 4. The same considerations apply for the thicknesses d2, d3 of the transition layers 101b, 101c which start to be formed at time t3 and t4, respectively.

It should be mentioned that the PECVD deposition of the uppermost SiO layer 12 can be arranged in situ without plasma interruption or with an intermediate plasma interrupt and plasma chamber purge, because in this embodiment the adhesion between SiON and amorphous silicon is controlled by introduction of the transition layers 101a, 101b, 101c.

This multi-layer stack 10a, 101a, 11a, 101b, 10b, 101c, 11b, 12 can now be structured by known lithography techniques in order to form a stable mask which may be used e.g. in pitch fragmentation or double-patterning techniques.

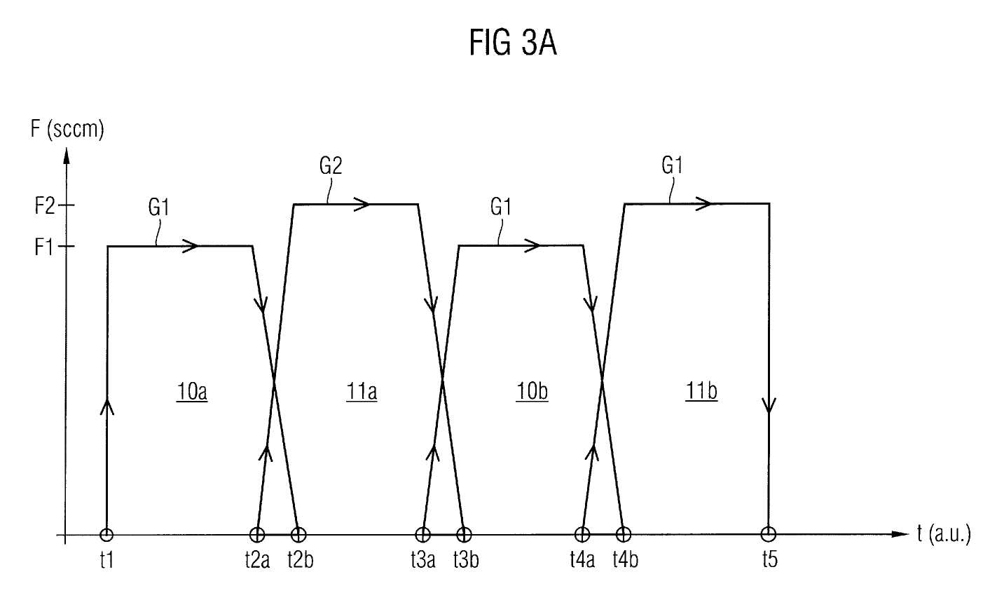

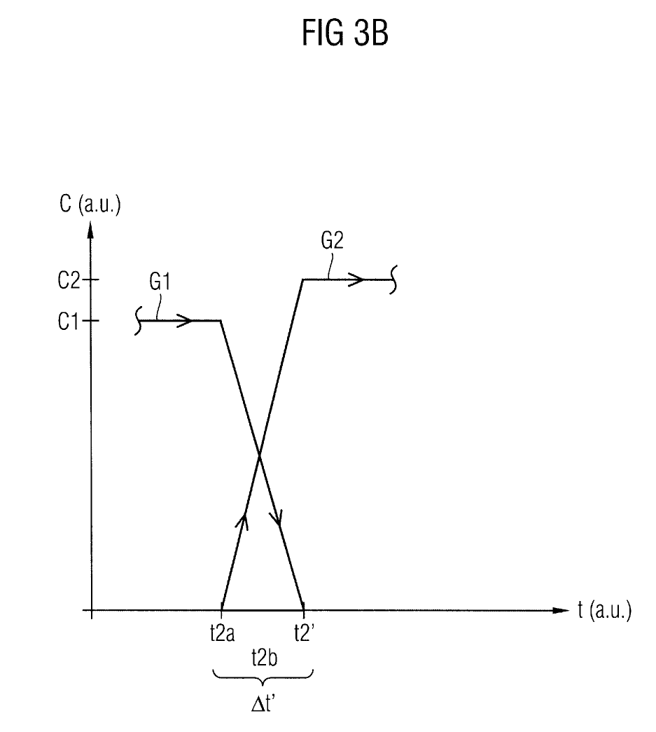

FIGS. 3a,b show time dependencies of a reaction gas flow rate and reaction gas concentration, respectively, of a plasma deposition process according to a second embodiment of the present invention.

In the second embodiment which is depicted in FIGS. 3a, 3b, the increase and decrease of the set point flow of the first reaction gas G1 and the increase and decrease of the set point flow of the second reaction gas G2 are actively controlled to have a certain linear time dependence. In other words, the transition between respective flows F1, F2 is even more smoothly than in the first embodiment shown in FIGS. 2a, 2b. For example, this can be achieved by gradually closing/opening respective valves.

The decrease of the flow F1 of the first reaction gas G1 starts at t2a and ends at t2b. Simultaneously, the increase of the flow F2 of the second reaction gas G2 starts at t2a and ends at t2b. Analogous increase/decrease behavior for F1, F2 is provided at times t3a, t3b, and t4a, t4b.

In comparison to the first embodiment, the gradual increase/decrease of the respective flows F1, F2 effects that the transition layers 101a, 101b, 101c have even larger thickness d1, d2, d3, respectively, because the thicknesses are proportional to the enhanced relaxation time Δt′>Δt as depicted in the diagram of FIG. 3b. Thus, it is possible to adapt the thickness of the transition layer in accordance with the interface properties, i.e. the adhesion properties of the material systems.

Although the present invention has been described with reference to preferred embodiments, it is not limited thereto, but can be modified in various manners which are obvious for a person skilled in the art. Thus, it is intended that the pre-sent invention is only limited by the scope of the claims attached herewith.

Particularly, the present invention is not limited to the material combinations referred to in the above embodiments. Although in the above-shown embodiments, the multi-layer stack consisted of the layer combination SiON/amorphous Si/SiON/amorphous Si/SiO, where the transition layer is between SiON and amorphous Si, also various other combinations could be used.

In principle, all conceivable combinations of Si-containing compounds could be used, in particular all combinations of SiO, SiN, SiON, amorphous Si, SiC, SiCO, . . . . In principle, even multi-layer stacks with arbitrary dielectrics could be deposited according to the invention.

Other systems, methods features and advantages of the invention will be or will become apparent to one with skill in the art. It is intended that all such additional systems, methods, features and advantages be included within this description, be within the scope of the invention, and be protected by the accompanying claims.

1. Manufacturing method for an integrated circuit comprising a multi-layer stack, said method comprising:
depositing a first layer on a substrate in a plasma deposition process in a plasma chamber using a first reaction gas having at least one first gas component which is introduced at a first flow rate into the chamber;
thereafter in situ depositing a second layer on the first layer in the plasma deposition process in the plasma chamber using a second reaction gas having at least one second gas component which is introduced at a second flow rate into the chamber;
wherein in a switching transition period from the first to the second flow rate a transition layer including a gradual composition transition from the first to the second layer is formed.

2. Manufacturing method according to claim 1, wherein during the switching transition period from the first to the second reaction gas all plasma parameters are kept constant and only the flow rate is switched from the first to the second flow rate.

3. Manufacturing method according to claim 1, wherein the flow rate is switched from the first to the second flow rate in a predetermined function of time.

4. Manufacturing method according to claim 3, wherein the predetermined function of time is linear.

5. Manufacturing method according to claim 1, wherein depositing a first layer and thereafter in situ depositing a second layer are repeated at least once.

6. Manufacturing method according to claim 1, wherein a thickness of the first and second layer is between 10 nm and 150 nm.

7. Manufacturing method according to claim 1, wherein said first layer is a SiON layer and said second layer is a amorphous silicon layer.

8. Manufacturing method according to claim 1, wherein said first layer is a SiN layer and said second layer is a amorphous silicon layer.

9. Manufacturing method according to claim 1, wherein said first layer is a SiON layer and said second layer is SiN layer.

10. Manufacturing method according to claim 1, wherein said first layer is a SiO layer and said second layer is a amorphous silicon layer.

11. Manufacturing method according to claim 1, wherein the first and second layers are formed of a dielectric silicon-containing material.

12. Manufacturing method according to claim 11, wherein the material is one of the group: Si, SiO, SiON, SiN, SiC, SiCO.

13. Manufacturing method according to claim 1, wherein the plasma is kept burning in a switching transition period from the first to the second reaction gas.

14. Integrated circuit comprising a multi-layer stack, said integrated circuit comprising:
a first layer on a substrate;
a second layer on the first layer; and
a transition layer including a gradual composition transition from the first to the second layer.

15. Integrated circuit according to claim 14, wherein a thickness of the first and second layer is between 10 nm and 150 nm.

16. Integrated circuit according to claim 14, wherein said first layer is a SiON layer and said second layer is a amorphous silicon layer.

17. Integrated circuit according to claim 14, wherein said first layer is a SiN layer and said second layer is a amorphous silicon layer.

18. Integrated circuit according to claim 14, wherein said first layer is a SiON layer and said second layer is SiN layer.

19. Integrated circuit according to claim 14, wherein said first layer is a SiO layer and said second layer is a amorphous silicon layer.

20. Integrated circuit according to claim 14, wherein the first and second layers are formed of a dielectric silicon-containing material.

21. Integrated circuit according to claim 20, wherein the material is one of the group: Si, SiO, SiON, SiN, SiC, SiCO.

22. A mask comprising a plurality of alternating first and second layers on a substrate, wherein a respective transition layer including a gradual composition transition from the first to the second layer is formed between each underlying first and overlying second layer pair, and wherein a respective transition layer including a gradual composition transition from the second to the first layer is formed between each underlying second and overlying first layer pair.
